(19) United States
(12) Patent Application Publication
(10) Pub. No.: US 2026/0231275 A1
(43) Pub. Date: Aug. 6, 2026

(54) WIRELESS CONNECTION MANAGEMENT SYSTEM

(71) Applicant: ELECOM CO., LTD., Osaka (JP)

(72) Inventor: Yoshiya FURUHATA, Osaka (JP)

(21) Appl. No.: 19/450,956

(22) Filed: Jan. 16, 2026

(30) Foreign Application Priority Data
Feb. 6, 2025 (JP) 2025-018258

(51) Int. Cl. H04W 76/25; H04W 60/04; H04W 72/51; H04W 76/15

(52) U.S. Cl. CPC H04W 76/25; H04W 60/04; H04W 72/51; H04W 76/15

(57) ABSTRACT

A wireless connection management system includes: an earphone set capable of maintaining simultaneous wireless connections with a plurality of devices; and at least one information storage section configured to store connection information on each of the plurality of devices, the connection information being information related to a wireless connection between the earphone set and the each of the plurality of devices. The earphone set is configured to refer to an item of the connection information which item is stored in the at least one information storage section and establish a wireless connection with a device among the plurality of devices which device corresponds to the item of the connection information. The at least one information storage section has an upper limit for the number of devices whose connection information is storable in the at least one information storage section, the upper limit being equal to a simultaneous-connection upper limit, which is an upper limit of the number of devices with which the earphone set is capable of maintaining simultaneous wireless connections.

### BACKGROUND OF THE INVENTION

### 1. Field of the Invention

The present invention relates to a wireless connection management system.

### 2. Description of the Related Art

A system described in Japanese Unexamined Patent Application Publication No. 2016-181869 is known as a wireless connection management system, for example. The wireless connection management system (a “playback system” in Japanese Unexamined Patent Application Publication No. 2016-181869) includes a playback device having a multi-pairing function and a multipoint function.

The multi-pairing function is a function to store a plurality of pieces of connection information (pairing information), each of which is information related to a wireless connection between an earphone set and a device. This function makes it possible to omit an operation to register connection information about a plurality of devices whose corresponding connection information is stored in the playback device.

The multipoint function is a function to maintain a state where the playback device is paired with a plurality of devices simultaneously (a state where the playback device is wirelessly connected to the plurality of devices simultaneously). This function allows the playback device to communicate with a plurality of devices simultaneously.

### SUMMARY OF THE INVENTION

Japanese Unexamined Patent Application Publication No. 2016-181869 does not describe details about the upper limit of the number of devices whose connection information is storable by the multi-pairing function, and the upper limit of the number of devices with which the playback device can maintain pairing by the multipoint function. Here, in the wireless connection management system described in Japanese Unexamined Patent Application Publication No. 2016-181869, it is conceivable, for example, that the playback device is an earphone set, the upper limit of the number of devices whose connection information is storable is five, and the upper limit of the number of devices with which the playback device can maintain pairing by the multipoint function is two.

In this configuration, in a case where connection information on five devices is stored in the earphone set, and the earphone set is turned on (powered on) with those five devices present in the vicinity of the earphone set, it is difficult to predict which two devices among the five devices are targeted for automatic pairing. As a result, the earphone set might be paired with unintended devices for a user.

An object of the present invention is to provide a wireless connection management system for wirelessly connecting an earphone set to a device intended by a user.

The present invention has the following feature. That is, a wireless connection management system according to the present invention includes: an earphone set capable of maintaining simultaneous wireless connections with a plurality of devices; and at least one information storage section configured to store connection information on each of the plurality of devices, the connection information being information related to a wireless connection between the earphone set and the each of the plurality of devices. The earphone set is configured to refer to an item of the connection information which item is stored in the at least one information storage section and establish a wireless connection with a device among the plurality of devices which device corresponds to the item of the connection information. The at least one information storage section has an upper limit for the number of devices whose connection information is storable in the at least one information storage section, the upper limit being equal to a simultaneous-connection upper limit, which is an upper limit of the number of devices with which the earphone set is capable of maintaining simultaneous wireless connections.

In this configuration, the upper limit of the number of devices whose connection information is storable is equal to the simultaneous-connection upper limit. Accordingly, for example, in a case where the earphone set is configured to be automatically wirelessly connectable with a device corresponding to connection information stored in the information storage section and the simultaneous-connection upper limit is two, when respective pieces of connection information corresponding to two particular devices (for example, one particular personal computer and one particular smartphone) are stored in the information storage section, and the earphone set is turned on (powered on) while multiple devices, including the two particular devices, are present in the vicinity of the earphone set, the earphone set always establishes wireless connections with the two particular devices. Accordingly, the user can predict with which two devices the earphone set establishes wireless connections. Hereby, the earphone set always establishes wireless connections with two devices intended by the user.

With this configuration, it is possible to achieve a wireless connection management system for wirelessly connecting an earphone set to a device intended by a user.

In the wireless connection management system according to the present invention, the at least one information storage section may include a plurality of information storage sections, including a first information storage section as one information storage section, and a second information storage section as another information storage section different from the first information storage section. The wireless connection management system may further include: at least one reception section configured to receive a human operation; and a connection control section configured to control the wireless connections of the earphone set based on the connection information and to switch between a plurality of control states, including a first state and a second state, in response to a human operation received by the at least one reception section, in such a manner that, in a case where the connection control section is in the first state, the connection control section controls the earphone set to establish a wireless connection with a device among the plurality of devices which device corresponds to an item of the connection information which item is stored in the first information storage section, and in a case where the connection control section is in the second state, the connection control section controls the earphone set to establish a wireless connection with a device among the plurality of devices which device corresponds to an item of the connection information which item is stored in the second information storage section.

With this configuration, the user can switch the control state of the connection control section between the first state and the second state by performing a human operation on the reception section. In a case where a device corresponding to the connection information stored in the first information storage section is different from a device corresponding to the connection information stored in the second information storage section, a device with which the earphone set is wirelessly connected is changed by switching the control state of the connection control section.

That is, with this configuration, it is possible to achieve a wireless connection management system that allows a user to easily change a device with which an earphone set is wirelessly connected.

The wireless connection management system according to the present invention may further include: a registration section configured to perform a registration process of registering a device targeted for wireless connection with the earphone set such that connection information on the device as a registration target is stored in a corresponding information storage section. In the case where the connection control section is in the first state, the registration section performs the registration process in such a manner as to store the connection information on the device as the registration target in the first information storage section, and in the case where the connection control section is in the second state, the registration section performs the registration process in such a manner as to store the connection information on the device as the registration target in the second information storage section.

With this configuration, the user can optionally select an information storage section in which the connection information is to be stored, by performing a human operation on the reception section. Accordingly, with this configuration, it is possible to appropriately use the first information storage section (the first state) and the second information storage section (the second state) in accordance with an application (for example, for private and for business).

The wireless communication management system according to the present invention may further include: a case capable of storing the earphone set. The at least one reception section may include a reception section for the earphones, and a reception section for the case.

With this configuration, the user can perform a human operation on an easily operable reception section out of the reception section of the earphone set and the reception section of the case, depending on the situation. This makes it possible to improve the convenience of the wireless connection management system.

The wireless communication management system according to the present invention may further include: a state notifier configured for notification of a current control state of the connection control section.

With this configuration, the user can grasp the current control state of the connection control section. This makes it possible to improve the convenience of the wireless connection management system.

The wireless communication management system according to the present invention may further include: a number notifier configured for notification of the number of devices whose connection information is stored in the at least one information storage section.

With this configuration, the user can grasp the number of devices whose connection information is stored in the information storage section. This allows the user to easily recognize the maximum number of devices with which the earphone set can automatically establish wireless connections.

### BRIEF DESCRIPTION OF THE DRAWINGS

FIG. 1 is a view illustrating an overview of a wireless connection management system;

FIG. 2 is a block diagram illustrating a configuration of the wireless connection management system;

FIG. 3 is a view illustrating a configuration of a touch display and the like;

FIG. 4 is a flowchart illustrating a registration flow; and

FIG. 5 is a flowchart illustrating a connection flow.

### DESCRIPTION OF THE PREFERRED EMBODIMENTS

An embodiment to carry out the present invention will be described with reference to the drawings.

### Overall Configuration of Wireless Connection Management System

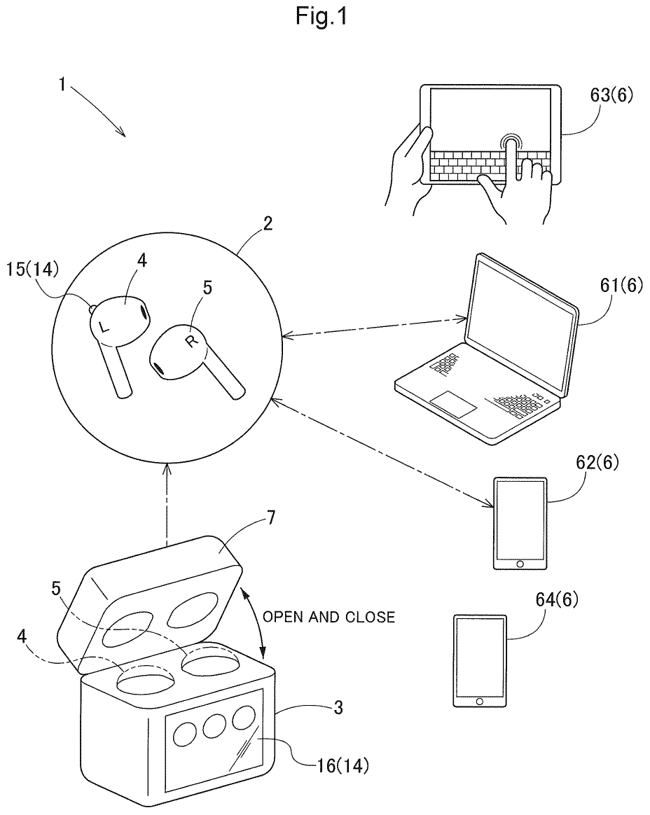

As illustrated in FIG. 1, a wireless connection management system 1 includes an earphone set 2. The earphone set 2 has a multi-pairing function and a multipoint function.

The multi-pairing function is a function to store a plurality of pieces of connection information (pairing information), each of which is information related to a wireless connection between the earphone set 2 and a device 6. This function makes it possible to omit an operation to register connection information about a plurality of devices 6 whose corresponding connection information is stored in an information storage section 20 (described later).

The multipoint function is a function to maintain a state where the earphone set 2 is wirelessly connected with a plurality of devices 6 simultaneously. This function allows the earphone set 2 to communicate with the plurality of devices 6 simultaneously. That is, the wireless connection management system 1 includes the earphone set 2 capable of maintaining simultaneous wireless connections with a plurality of devices 6.

For example, in FIG. 1, a first terminal 61, a second terminal 62, a third terminal 63, and a fourth terminal 64 are illustrated. The first terminal 61, the second terminal 62, the third terminal 63, and the fourth terminal 64 correspond to devices 6.

In the present embodiment, the first terminal 61 is a laptop PC. The second terminal 62 is a smartphone. The third terminal 63 is a tablet terminal. The fourth terminal 64 is a smartphone different from the second terminal 62. In the example illustrated in FIG. 1, the earphone set 2 is wirelessly connected with the first terminal 61 and the second terminal 62 simultaneously.

A simultaneous-connection upper limit in the present embodiment is two. The simultaneous-connection upper limit is the upper limit of the number of devices 6 with which the earphone set 2 is capable of maintaining simultaneous wireless connections. However, the present invention is not limited to this. The simultaneous-connection upper limit may be any number of three or more.

Although not limited in particular, a wireless connection method between the earphone set 2 and the device 6 may be a short-distance wireless communications method. Particularly, the earphone set 2 may be wirelessly connected with the device 6 by Bluetooth (registered trademark), for example.

As illustrated in FIG. 1, the earphone set 2 includes a left chassis 4 and a right chassis 5. The left chassis 4 is attachable to the left ear of a user. The right chassis 5 is attachable to the right ear of the user.

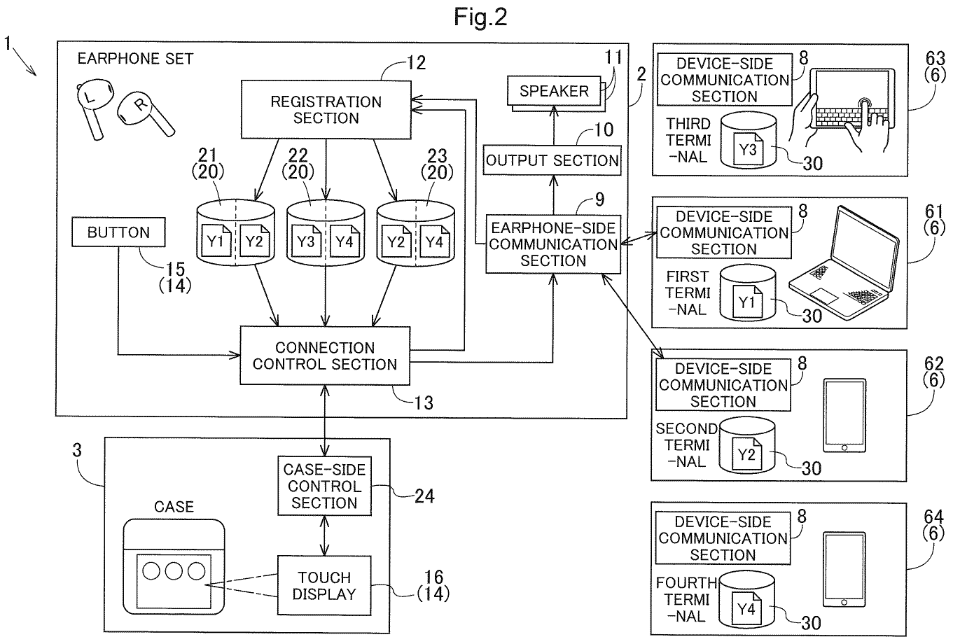

As illustrated in FIG. 2, the earphone set 2 includes two speakers 11 that can output audio. One speaker 11 out of the two speakers 11 is provided for the left chassis 4, and the other one speaker 11 is provided for the right chassis 5.

As illustrated in FIG. 2, each device 6 includes a device-side communication section 8. The earphone set 2 includes an earphone-side communication section 9 and an output section 10. The earphone-side communication section 9 is communicable with the device-side communication section 8 of a device 6 with which the earphone set 2 is wirelessly connected.

In response to audio data sent from the device-side communication section 8 to the earphone-side communication section 9, the earphone-side communication section 9 sends the audio data to the output section 10. The output section 10 sends an electrical signal based on the audio data to each speaker 11. Each speaker 11 outputs audio in accordance with the electrical signal. Hereby, the audio of the device 6 with which the earphone set 2 is wirelessly connected is output from each speaker 11.

Note that the earphone set 2 may be worn by being fitted into (or hooked onto) a predetermined portion of the auricle of the user or may include audio output sections each configured to cover the auricle (or configured to be pressed against the auricle or a region around the auricle) such that the earphone set 2 is worn by fixing the audio output sections in position to the head of the user by a headband or the like (for example, so-called headphones). That is, the “earphone set” according to the present invention includes headphones.

As illustrated in FIG. 1, the wireless connection management system 1 also includes a case 3. The case 3 includes an openable and closeable cover 7 and is capable of storing the earphone set 2 (in other words, the left chassis 4 and the right chassis 5). That is, the wireless connection management system 1 includes the case 3 capable of storing the earphone set 2.

### Information Storage Section and Registration Section

As illustrated in FIG. 2, the earphone set 2 includes a plurality of information storage sections 20. In the present embodiment, three information storage sections 20 are provided. However, the present invention is not limited to this, and the number of information storage sections 20 to be provided may be any number.

More specifically, as illustrated in FIG. 2, the earphone set 2 includes a first information storage section 21, a second information storage section 22, and a third information storage section 23. The first information storage section 21, the second information storage section 22, and the third information storage section 23 correspond to the information storage sections 20.

That is, the wireless connection management system 1 includes a plurality of information storage sections 20. The plurality of information storage sections 20 in the present embodiment includes the first information storage section 21 as one information storage section 20, and the second information storage section 22 as another information storage section 20 different from the first information storage section 21.

Each information storage section 20 is configured to store connection information on a corresponding device 6. The connection information is information related to a wireless connection between the earphone set 2 and the device 6. That is, the wireless connection management system 1 includes the information storage sections 20 each configured to store connection information on a corresponding device 6, the connection information being information related to a wireless connection between the earphone set 2 and the corresponding device 6.

As illustrated in FIG. 2, the earphone set 2 also includes a registration section 12. The registration section 12 is configured to perform a registration process. The registration process is a process of registering a device 6 targeted for the wireless connection with the earphone set 2. That is, the wireless connection management system 1 includes the registration section 12 configured to perform a registration process of registering a device 6 targeted for the wireless connection with the earphone set 2.

The registration section 12 is configured to store connection information on a device 6 as a registration target in the information storage section 20 in the registration process. The following describes details of the registration process.

As illustrated in FIG. 2, each device 6 includes a storage section 30. The storage section 30 stores connection information on the device 6 in which the storage section 30 is provided.

In the present embodiment, the storage section 30 of the first terminal 61 stores first connection information Y1. The first connection information Y1 is connection information and is information related to a wireless connection between the earphone set 2 and the first terminal 61.

The storage section 30 of the second terminal 62 stores second connection information Y2. The second connection information Y2 is connection information and is information related to a wireless connection between the earphone set 2 and the second terminal 62.

The storage section 30 of the third terminal 63 stores third connection information Y3. The third connection information Y3 is connection information and is information related to a wireless connection between the earphone set 2 and the third terminal 63.

The storage section 30 of the fourth terminal 64 stores fourth connection information Y4. The fourth connection information Y4 is connection information and is information related to a wireless connection between the earphone set 2 and the fourth terminal 64.

In the registration process, the device 6 as a registration target sends connection information corresponding to the device 6 to the earphone-side communication section 9 via the device-side communication section 8. The registration section 12 acquires the connection information from the earphone-side communication section 9. The registration section 12 causes the information storage section 20 (more specifically, any of the first information storage section 21, the second information storage section 22, and the third information storage section 23) to store the acquired connection information.

For example, in a case where the first terminal 61 is targeted for registration, the first terminal 61 sends the first connection information Y1 to the earphone-side communication section 9 via the device-side communication section 8. The registration section 12 acquires the first connection information Y1 from the earphone-side communication section 9. The registration section 12 causes the information storage section 20 (more specifically, any of the first information storage section 21, the second information storage section 22, and the third information storage section 23) to store the acquired first connection information Y1.

### Reception Section

As illustrated in FIG. 2, the earphone set 2 includes a connection control section 13. Although details are described later, the connection control section 13 is configured to control the earphone-side communication section 9 to control a wireless connection between the earphone set 2 and the device 6.

The case 3 includes a case-side control section 24. The case-side control section 24 is communicable with the connection control section 13. Any method can be employed as a communication method between the connection control section 13 and the case-side control section 24.

As illustrated in FIGS. 1, 2, in the present embodiment, the earphone set 2 and the case 3 each include a reception section 14. Each reception section 14 is configured to receive a human operation performed by the user. That is, the wireless connection management system 1 includes the reception section 14 configured to receive a human operation.

More specifically, the reception section 14 of the earphone set 2 is a button 15. Although not limited in particular, the button 15 is provided in the left chassis 4. The user can perform a human operation (more specifically, a push operation) on the button 15.

The reception section 14 of the case 3 is a touch display 16 (corresponding to a “state notifier” and a “number notifier” according to the present invention). The touch display 16 can display various pieces of information. The case-side control section 24 is configured to control the touch display 16. The user can perform a human operation (more specifically, a touch operation) on the touch display 16.

The connection control section 13 illustrated in FIG. 2 is configured to switch between a plurality of control states including a first state and a second state in response to a human operation received by each reception section 14. In the present embodiment, the connection control section 13 can switch between three control states including the first state, the second state, and a third state.

More specifically, as illustrated in FIG. 2, in response to the button 15 receiving a human operation, a predetermined signal is sent from the button 15 to the connection control section 13. The connection control section 13 switches a control state based on the signal.

More specifically, upon receipt of the signal by the connection control section 13 while the control state is the first state, the control state is switched to the second state. Upon receipt of the signal by the connection control section 13 while the control state is the second state, the control state is switched to the third state. Upon receipt of the signal by the connection control section 13 while the control state is the third state, the control state is switched to the first state.

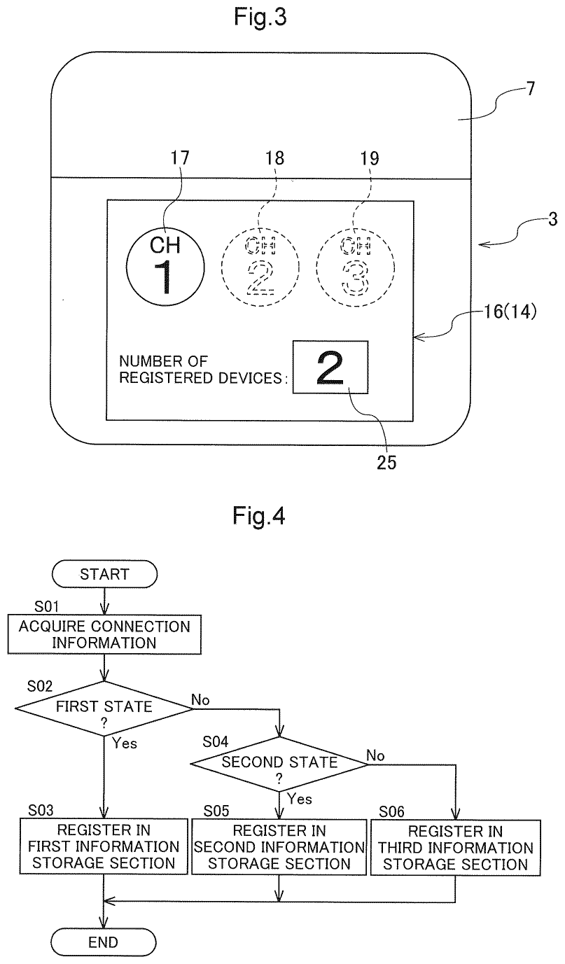

As illustrated in FIG. 3, a first touch button 17, a second touch button 18, and a third touch button 19 are displayed on the touch display 16. The first touch button 17, the second touch button 18, and the third touch button 19 correspond to the first state, the second state, and the third state, respectively.

In response to a human operation performed on any one of the first touch button 17, the second touch button 18, and the third touch button 19, predetermined information is sent from the touch display 16 to the case-side control section 24 as illustrated in FIG. 2. The case-side control section 24 sends a predetermined signal to the connection control section 13 based on the information. The connection control section 13 switches the control state based on the signal.

More specifically, the connection control section 13 switches the control state to a control state corresponding to one of the first touch button 17, the second touch button 18, and the third touch button 19 which one receives the human operation. For example, upon receipt of a human operation by the second touch button 18 while the control state is the first state, the control state is switched to the second state.

### Registration Flow

The registration section 12 is configured to perform the registration process in accordance with the registration flow illustrated in FIG. 4. The following describes details of the registration flow. Although not limited in particular, the registration section 12 may be configured to start the registration flow in response to a predetermined registration operation (a pairing operation) performed by the user, for example. The registration operation may be any operation (for example, a long-push operation for a predetermined push button, a predetermined operation for the device 6 as a registration target, and the like).

When the registration flow is started, the process of step S01 is first performed. In step S01, the registration section 12 acquires connection information from the earphone-side communication section 9 as described above. Note that the connection information is connection information corresponding to the device 6 as a registration target and information sent from the device 6 to the earphone-side communication section 9. After that, the process proceeds to step S02.

In step S02, the registration section 12 determines whether the control state of the connection control section 13 is the first state or not.

Here, as illustrated in FIG. 2, the registration section 12 is configured to continue acquiring information indicating a current (latest) control state from the connection control section 13. The registration section 12 performs the determination in step S02 and a determination in step S04 (described later) in FIG. 4 based on the information acquired as such.

In a case where the control state is the first state (“Yes” in step S02), the process proceeds to step S03. In a case where the control state is not the first state (“No” in step S02), the process proceeds to step S04.

In step S03 in FIG. 4, the registration section 12 registers (in other words, stores) the connection information acquired in step S01 in the first information storage section 21 as illustrated in FIG. 2. After that, the registration flow ends.

In Step S04 in FIG. 4, the registration section 12 determines whether the control state of the connection control section 13 is the second state or not. In a case where the control state is the second state (“Yes” in step S04), the process proceeds to step S05. In a case where the control state is not the second state (“No” in step S04), the process proceeds to step S06.

In step S05 in FIG. 4, the registration section 12 registers (in other words, stores) the connection information acquired in step S01 in the second information storage section 22 as illustrated in FIG. 2. After that, the registration flow ends.

In step S06 in FIG. 4, the registration section 12 registers (in other words, stores) the connection information acquired in step S01 in the third information storage section 23 as illustrated in FIG. 2. After that, the registration flow ends.

With the configuration described above, in a case where the registration process is performed while the connection control section 13 is in the first state, the registration section 12 stores connection information on the device 6 as a registration target, in the first information storage section 21. In a case where the registration process is performed while the connection control section 13 is in the second state, the registration section 12 stores connection information on the device 6 as a registration target, in the second information storage section 22. In a case where the registration process is performed while the connection control section 13 is in the third state, the registration section 12 stores connection information on the device 6 as a registration target, in the third information storage section 23.

### Storage Upper Limit

In the wireless connection management system 1, a storage upper limit is equal to the simultaneous-connection upper limit. The storage upper limit is the upper limit of the number of devices 6 whose connection information is storable in the information storage section 20 (one information storage section 20 in a case where a plurality of information storage sections 20 is provided). In other words, the storage upper limit is the upper limit of the number of devices 6 whose connection information can be stored by the multi-pairing function.

As described above, the simultaneous-connection upper limit of the earphone set 2 in the present embodiment is two. Therefore, the storage upper limit is also two. However, the present invention is not limited to this. As far as the storage upper limit is equal to the simultaneous-connection upper limit, the storage upper limit may be any number of three or more.

Thus, the upper limit of the number of devices 6 whose connection information is storable in the information storage section 20 is equal to the simultaneous-connection upper limit, which is the upper limit of the number of devices 6 with which the earphone set 2 is capable of maintaining simultaneous wireless connections.

In the example illustrated in FIG. 2, pieces of connection information on two devices 6 are stored in each of the first information storage section 21, the second information storage section 22, and the third information storage section 23. That is, in any of the first information storage section 21, the second information storage section 22, and the third information storage section 23, the number of devices 6 whose connection information is stored reaches the storage upper limit. Accordingly, even if the above-mentioned registration process is performed in this state, the number of pieces of connection information stored in each information storage section 20 does not increase.

Here, the wireless connection management system 1 may be configured such that, in a case where the number of devices 6 whose connection information is stored has already reached the storage upper limit in the information storage section 20 in which connection information is to be stored, at the time when any of the processes of step S03, step S05, and step S06 illustrated in FIG. 4 is performed, the oldest connection information among pieces of connection information stored in the information storage section 20 is overwritten with connection information of a device 6 to be newly registered, or the registration process is ended (cancelled) without registering (in other words, storing) the connection information of the device 6 to be newly registered, in the information storage section 20.

### Notification of Control State

The case-side control section 24 illustrated in FIG. 2 is configured to continue acquiring information indicating a current (latest) control state from the connection control section 13. The case-side control section 24 controls the touch display 16 based on the information to change display modes of the first touch button 17, the second touch button 18, and the third touch button 19.

More specifically, the case-side control section 24 displays, on the touch display 16, a touch button corresponding to the current control state of the connection control section 13 in the most emphasized manner from among the first touch button 17, the second touch button 18, and the third touch button 19.

For example, in a case where the current control state of the connection control section 13 is the first state, the first touch button 17 is displayed in the most emphasized manner among the first touch button 17, the second touch button 18, and the third touch button 19, as illustrated in FIG. 3.

With this configuration, the current control state of the connection control section 13 is notified by the display modes of the first touch button 17, the second touch button 18, and the third touch button 19 on the touch display 16. That is, the wireless connection management system 1 includes the touch display 16 configured to notify the current control state of the connection control section 13.

Although not limited in particular, two touch buttons other than the touch button displayed in the most emphasized manner among the first touch button 17, the second touch button 18, and the third touch button 19 may be displayed relatively lightly or may not be displayed.

### Number Notification Region

The case-side control section 24 illustrated in FIG. 2 is configured to acquire storage number information on each information storage section 20. The storage number information of the information storage section 20 is information indicating the number of devices 6 whose connection information is stored in the information storage section 20. As illustrated in FIG. 2, the storage number information is sent from each information storage section 20 to the case-side control section 24 via the connection control section 13.

As illustrated in FIG. 3, the case-side control section 24 displays, on a number notification region 25 on the touch display 16, the number of devices 6 whose connection information is stored in the information storage section 20 (in other words, the number of registered devices 6) based on the acquired storage number information.

At this time, the case-side control section 24 displays the number of devices 6 whose connection information is stored, in terms of one of the plurality of information storage sections 20. More specifically, the case-side control section 24 displays, on the number notification region 25, the number of devices 6 whose connection information is stored in the information storage section 20 corresponding to the current (latest) control state of the connection control section 13. Note that, in the present embodiment, the first information storage section 21, the second information storage section 22, and the third information storage section 23 correspond to the first state, the second state, and the third state, respectively.

For example, in the example illustrated in FIG. 3, the current control state of the connection control section 13 is the first state. Accordingly, the number of devices 6 whose connection information is stored in the first information storage section 21 is displayed on the number notification region 25.

As such, the wireless connection management system 1 includes the touch display 16 configured to notify the number of devices 6 whose connection information is stored in the information storage section 20.

As illustrated in FIG. 3, the number notification region 25 is displayed on the touch display 16 together with (at the same time as) the first touch button 17, the second touch button 18, and the third touch button 19. That is, the touch display 16 notifies (displays), on the same screen, the current control state of the connection control section 13, and the number of devices 6 whose connection information is stored in the information storage section 20 corresponding to the control state.

### Connection Flow

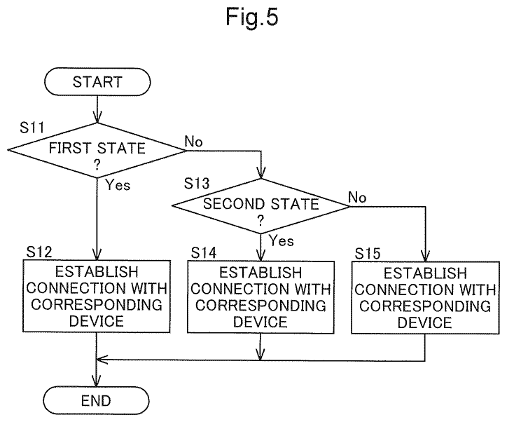

The connection control section 13 is configured to control the wireless connection of the earphone set 2 in accordance with the connection flow illustrated in FIG. 5. The following describes details of the connection flow. Although not limited in particular, the connection control section 13 may be configured to start the connection flow at the time when the earphone set 2 is turned on (powered on). In the following description of the connection flow, the first terminal 61, the second terminal 62, the third terminal 63, and the fourth terminal 64 are present in the vicinity of the earphone set 2 (in other words, within a range where the earphone set 2 is wirelessly connectable).

When the connection flow is started, the process of step S11 is performed. In step S11, the connection control section 13 determines whether the control state of the connection control section 13 is the first state or not.

In a case where the control state is the first state (“Yes” in step S11), the process proceeds to step S12. In a case where the control state is not the first state (“No” in step S11), the process proceeds to step S13.

In step S12, the connection control section 13 acquires, from the information storage section 20 corresponding to the first state, all pieces of connection information stored in the information storage section 20. The connection control section 13 controls the wireless connection of the earphone set 2 by controlling the earphone-side communication section 9 such that the earphone set 2 establishes a wireless connection with a device 6 corresponding to each of the pieces of connection information. Hereby, a state (a state where the wireless connection is established) where the device 6 (more specifically, the device-side communication section 8) and the earphone set 2 (more specifically, the earphone-side communication section 9) are wirelessly connected with each other is automatically established. Here, the information storage section 20 corresponding to the first state is more specifically the first information storage section 21.

For example, in the example illustrated in FIG. 2, the first connection information Y1 and the second connection information Y2 are stored in the first information storage section 21. Accordingly, in this example, in response to execution of the process of step S12 in FIG. 5, the earphone set 2 is automatically wirelessly connected with the first terminal 61 and the second terminal 62 simultaneously.

In a case where the connection control section 13 is in the first state, the connection control section 13 controls the wireless connection of the earphone set 2 such that the earphone set 2 establishes a wireless connection with the device 6 corresponding to the connection information stored in the first information storage section 21.

After step S12, the connection flow ends.

In step S13, the connection control section 13 determines whether the control state of the connection control section 13 is the second state or not.

In a case where the control state is the second state (“Yes” in step S13), the process proceeds to step S14. In a case where the control state is not the second state (“No” in step S13), the process proceeds to step S15.

In step S14, the connection control section 13 acquires, from the information storage section 20 corresponding to the second state, all pieces of connection information stored in the information storage section 20. Then, the connection control section 13 controls the wireless connection of the earphone set 2 by controlling the earphone-side communication section 9 such that the earphone set 2 establishes a wireless connection with a device 6 corresponding to each of the pieces of connection information. Hereby, a state (a state where the wireless connection is established) where the device 6 (more specifically, the device-side communication section 8) and the earphone set 2 (more specifically, the earphone-side communication section 9) are wirelessly connected with each other is automatically established. Here, the information storage section 20 corresponding to the second state is more specifically the second information storage section 22.

For example, in the example illustrated in FIG. 2, the third connection information Y3 and the fourth connection information Y4 are stored in the second information storage section 22. Accordingly, in this example, in response to execution of the process of step S14 in FIG. 5, the earphone set 2 is automatically wirelessly connected with the third terminal 63 and the fourth terminal 64 simultaneously.

In a case where the connection control section 13 is in the second state, the connection control section 13 controls the wireless connection of the earphone set 2 such that the earphone set 2 establishes a wireless connection with the device 6 corresponding to the connection information stored in the second information storage section 22.

After step S14, the connection flow ends.

In step S15, the connection control section 13 acquires, from the information storage section 20 corresponding to the third state, all pieces of connection information stored in the information storage section 20. Then, the connection control section 13 controls the wireless connection of the earphone set 2 by controlling the earphone-side communication section 9 such that the earphone set 2 establishes a wireless connection with the device 6 corresponding to the connection information. Hereby, a state (a state where the wireless connection is established) where the device 6 (more specifically, the device-side communication section 8) and the earphone set 2 (more specifically, the earphone-side communication section 9) are wirelessly connected with each other is automatically established. Here, the information storage section 20 corresponding to the third state is more specifically the third information storage section 23.

For example, in the example illustrated in FIG. 2, the second connection information Y2 and the fourth connection information Y4 are stored in the third information storage section 23. Accordingly, in this example, in response to execution of the process of step S15 in FIG. 5, the earphone set 2 is automatically wirelessly connected with the second terminal 62 and the fourth terminal 64 simultaneously.

After step S15, the connection flow ends.

With the configuration described above, the connection control section 13 controls the wireless connection of the earphone set 2 based on connection information. That is, the wireless connection management system 1 includes the connection control section 13 configured to control the wireless connection of the earphone set 2 based on connection information. The earphone set 2 is configured to refer to connection information stored in the information storage section 20 and establish a wireless connection with a device 6 corresponding to the connection information.

Note that each element such as the earphone-side communication section 9 and the output section 10 illustrated in FIG. 2 may be a physical device such as a microcomputer or may be a functional section in software. For example, a program corresponding to each functional section may be stored in a ROM or a nonvolatile memory (not illustrated), and a process corresponding to each functional section may be executed by loading the program to a CPU and executing the program.

In the configuration described above, the upper limit of the number of devices 6 whose connection information is storable is equal to the simultaneous-connection upper limit. Accordingly, for example, in a case where the earphone set 2 is configured to be automatically wirelessly connectable to a device 6 corresponding to connection information stored in the information storage section 20 and the simultaneous-connection upper limit is two, when respective pieces of connection information corresponding to two particular devices 6 (for example, one particular personal computer and one particular smartphone) are stored in the information storage section 20, and the earphone set 2 is turned on (powered on) while multiple devices 6, including the two particular devices 6, are present in the vicinity of the earphone set 2, the earphone set 2 always establishes wireless connections with the two particular devices 6. Accordingly, the user can predict with which two devices 6 the earphone set 2 establishes wireless connections. Hereby, the earphone set 2 always establishes wireless connections with two devices 6 intended by the user.

With the configuration described above, it is possible to achieve the wireless connection management system 1 for wirelessly connecting the earphone set 2 to the device 6 intended by the user.

### Other Embodiments

(1) A voice notifier configured to notify the current control state of the connection control section 13 by voice may be provided. In this case, the voice notifier corresponds to the “state notifier” according to the present invention.

(2) A voice notifier configured to notify, by voice, the number of devices 6 whose connection information is stored in the information storage section 20 may be provided. In this case, the voice notifier corresponds to the “number notifier” according to the present invention.

(3) Each information storage section 20 may be provided in an external device outside the earphone set 2.

(4) The earphone-side communication section 9, the output section 10, the registration section 12, the connection control section 13, the button 15, and each information storage section 20 may be provided in the left chassis 4, may be provided in the right chassis 5, or may be separately (dispersedly) provided in the left chassis 4 and the right chassis 5.

(5) The reception section 14 may be omitted.

(6) The registration section 12 may be configured to determine the information storage section 20 in which connection information is to be stored (registered) in the registration process, regardless of the control state of the connection control section 13.

(7) The case 3 may be omitted.

The features of the embodiments described above (including other embodiments, which also applies hereinafter) may be combined with a feature disclosed in another embodiment, provided that such a combination does not result in a contradiction. The embodiments described in the present specification are illustrative and should not be construed as limiting the present invention. Modifications to the present invention are permissible, as long as they do not deviate from the scope that can achieve the objects of the present invention.

### INDUSTRIAL APPLICABILITY

The present invention is applicable to a wireless connection management system.

### DESCRIPTION OF THE REFERENCE NUMERALS

1: wireless connection management system
2: earphone set
3: case
6: device
12: registration section
13: connection control section
14: reception section
16: touch display (state notifier, number notifier)
20: information storage section
21: first information storage section
22: second information storage section

What is claimed is:

1. A wireless connection management system, comprising:
an earphone set capable of maintaining simultaneous wireless connections with a plurality of devices; and
at least one information storage section configured to store connection information on each of the plurality of devices, the connection information being information related to a wireless connection between the earphone set and the each of the plurality of devices,
the earphone set being configured to refer to an item of the connection information which item is stored in the at least one information storage section and establish a wireless connection with a device among the plurality of devices which device corresponds to the item of the connection information,
the at least one information storage section having an upper limit for the number of devices whose connection information is storable in the at least one information storage section, the upper limit being equal to a simultaneous-connection upper limit, which is an upper limit of the number of devices with which the earphone set is capable of maintaining simultaneous wireless connections.

2. The wireless connection management system according to claim 1, wherein
the at least one information storage section includes a plurality of information storage sections, including a first information storage section as one information storage section, and a second information storage section as another information storage section different from the first information storage section, and
the wireless communication management system further comprises:
at least one reception section configured to receive a human operation; and
a connection control section configured to control the wireless connections of the earphone set based on the connection information and to switch between a plurality of control states, including a first state and a second state, in response to a human operation received by the at least one reception section, in such a manner that, in a case where the connection control section is in the first state, the connection control section controls the earphone set to establish a wireless connection with a device among the plurality of devices which device corresponds to an item of the connection information which item is stored in the first information storage section, and in a case where the connection control section is in the second state, the connection control section controls the earphone set to establish a wireless connection with a device among the plurality of devices which device corresponds to an item of the connection information which item is stored in the second information storage section.

3. The wireless connection management system according to claim 2, further comprising:
a registration section configured to perform a registration process of registering a device targeted for wireless connection with the earphone set such that connection information on the device as a registration target is stored in a corresponding information storage section, wherein
in the case where the connection control section is in the first state, the registration section performs the registration process in such a manner as to store the connection information on the device as the registration target in the first information storage section, and
in the case where the connection control section is in the second state, the registration section performs the registration process in such a manner as to store the connection information on the device as the registration target in the second information storage section.

4. The wireless connection management system according to claim 2, further comprising:
a case capable of storing the earphone set, wherein
the at least one reception section includes a reception section for the earphone set, and a reception section for the case.

5. The wireless connection management system according to claim 2, further comprising:
a state notifier configured for notification of a current control state of the connection control section.

6. The wireless connection management system according to claim 1, further comprising:
a number notifier configured for notification of the number of devices whose connection information is stored in the at least one information storage section.
